(19) United States
(12) Patent Application Publication
(10) Pub. No.: US 2008/0227899 A1
(43) Pub. Date: Sep. 18, 2008

(54) Novel method for polymer RDP-clay nanocomposites and mechanisms for polymer/polymer blending

(76) Inventors: David Abecassis, Huntington, NY (US); Ed Wiegel, Baltimore, MD (US)

Correspondence Address: Thomas A. O'Rourke;Bodner & O'Rourke, 425 Broadhollow Road, Melville, NY, 11747, US

(21) Appl. No.: 12/072,504

(22) Filed: Feb. 26, 2008

Related U.S. Application Data
(63) Continuation-in-part of application No. 11/801,993, filed on May 11, 2007.
Application No. 11/801,993 is a continuation-in-part of application No. 11/645,093, filed on Dec. 22, 2006.
(60) Provisional application No. 60/903,501, filed on Feb. 26, 2007.
(60) Provisional application No. 60/799,489, filed on May 11, 2006.

(51) Int. Cl. C08K 5/521; C08K 3/34

(52) U.S. Cl. 524/147; 524/445

(57) ABSTRACT

The invention is directed towards additives for thermoplastic polymers and blends thereof to which an organoclays has been added to form microtactoids in the thermoplastic. The Organoclays are blends of one or more clays which have been treated with one or more of, resorcinol diphosphate, bis-phenol diphosphate or bis(3-T-Butyl-4 hydroxyphenyl-2,4 Di-T-butylphenyl) resorcinol diphosphate or hydroxyl-derived ethers, esters, and amides where aliphatic fatty acids are added to the molecule at the hydroxyl site.

This application claims priority on U.S. Provisional Patent Application Ser. No. 60/903,501 filed Feb. 26, 2007, the disclosures of which are incorporated herein by reference. This application is a continuation in part of U.S. application Ser. No. 11/801,993 filed May 11, 2007 which claims priority on U.S. Provisional Application Ser. No. 60/799,489 filed May 11, 2006 the disclosures of which are incorporated herein by reference. This application is also a continuation in part of U.S. application Ser. No. 11/645,093 filed Dec. 22, 2006, which claims priority on U.S. Provisional application Ser. No. 60/733,678, the disclosures of which are incorporated herein by reference.

### FIELD

The invention is directed towards plastics additives and the thermoplastic industry. The invention is more specifically directed towards the use of mechanisms involving one or more organoclays which have been treated with one or more of, resorcinol diphosphate, bis-phenol diphosphate or bis(3-T-Butyl-4 hydroxyphenyl-2,4 Di-T-butylphenyl) resorcinol diphosphate or hydroxyl-derived ethers, esters, and amides where aliphatic fatty acids are added to the molecule at the hydroxyl site

### BACKGROUND OF THE INVENTION

Clay particles can be added to and blended with thermoplastics during melt processing to make thermoplastic nanocomposites. However, the surface of the individual particles usually must be treated with an organic surfactant so as to allow compatibility with the given plastic and thus facilitate dispersion of the individual clay molecules during melt blending. Plastics for the most part are hydrophobic or largely non polar and this poses a problem for dispersing polar compounds such as smectite clays and kaolin clays such as halloysites as well as other nanosized clays. Without the proper surfactant on the particle surface, the clay particles tend to agglomerate as they precipitate into clumps inside the thermoplastic.

Current state of the art is to use quaternary amine salts to ionically bond non-polar molecules to the clay crystal surface. Another common method is to use grafted polymer chains which are synthesized using polymer oligomers covalently attached to the clay hydroxyl group.

The clumps of non dispersed clay particles frequently found in prior art clay blends with thermoplastic materials are usually detrimental to the mechanical properties of the plastic. The clumps of clay particles are technically referred to as tactoids. Non-quaternary amine salt treated clays do not form nano-sized particles in most plastics, and do not disperse in most plastics since clay molecules are polar thus preventing complete dispersion throughout the blend. The more uniform the dispersion of these clay particles in the thermoplastic, the better the plastics' properties are.

Currently, quaternary amine salt treated organoclays are the most commonly available commercial grade nanotechnology blended in thermoplastics. Organoclays impart UV, chemical and mechanical resistance to the plastic as well as conferring mixing and dispersion enhancement for polymer blends and filler dispersion when the exfoliated form is used with the right surfactant. The quaternary amine treated clays can form tactoids in plastics when their functional groups are not compatible with the plastics in which they are used. This incompatibility can be overcome with the selection and use of different functional groups on the aliphatic portion of the quaternary amine.

### OBJECTS OF THE INVENTION

It is an object of the invention is to provide a nanocomposite composition that fully exfoliates without significant tactoid formation.

It is also an object of the invention to provide a method of nanocomposite formation from blends of a clay and resorcinol diphosphate and/or bis-phenol diphosphate and/or bis(3-T-Butyl-4 hydroxyphenyl-2,4 Di-T-butylphenyl) resorcinol diphosphate and it's hydroxyl-derived ethers, esters, and amides where aliphatic fatty acids are added to the molecule polymers.

It is a still further object of the invention to provide blends of thermoplastic polymers which have been treated with resorcinol diphosphate and/or bis-phenol diphosphate and/or bis(3-T-Butyl-4 hydroxyphenyl-2,4 Di-T-butylphenyl) resorcinol diphosphate and it's hydroxyl-derived ethers, esters, and amides where aliphatic fatty acids are added to the molecule

It is another object of the invention to provide resorcinol diphosphate and/or bis-phenol diphosphate and/or bis(3-T-Butyl-4 hydroxyphenyl-2,4 Di-T-butylphenyl) resorcinol diphosphate based compounds where the OH from the phosphate has been reacted to form ethers, esters, and amides where aliphatic fatty acids are added to the molecule.

It is still another object of the invention where the blends of clay and resorcinol diphosphate and/or bis-phenol diphosphate and/or bis(3-T-Butyl-4 hydroxyphenyl-2,4 Di-T-butylphenyl) resorcinol diphosphate and it's hydroxyl-derived ethers, esters, and amides where aliphatic fatty acids are added to the molecule polymers form compositions where the clay fully exfoliates without significant tactoid formation.

It is an object of the invention to provide a nanocomposite blend of a thermoplastic and an organoclay treated with a resorcinol diphosphate a bis-phenol diphosphate a bis(3-T-Butyl-4 hydroxyphenyl-2,4 Di-T-butylphenyl) resorcinol diphosphate or blends thereof.

It is an object of the invention to provide a nanocomposite blend of a thermoplastic and an organoclay treated with a hydroxyl-derived ether, ester, and/or amide of resorcinol diphosphate a bis-phenol diphosphate a bis(3-T-Butyl-4 hydroxyphenyl-2,4 Di-T-butylphenyl) resorcinol diphosphate or blends thereof.

It is an object of the invention to provide a method of forming a nanocomposite from a thermoplastic and an organoclay treated with a resorcinol diphosphate a bis-phenol diphosphate a bis(3-T-Butyl-4 hydroxyphenyl-2,4 Di-T-butylphenyl) resorcinol diphosphate or blends thereof.

It is an object of the invention to provide a method of forming a nanocomposite blend of a thermoplastic and an organoclay treated with a hydroxyl-derived ether, ester, and/or amide of resorcinol diphosphate a bis-phenol diphosphate a bis(3-T-Butyl-4 hydroxyphenyl-2,4 Di-T-butylphenyl) resorcinol diphosphate or blends thereof. Yet another object of the invention is the mechanism for the above mentioned organoclay where the clay has only partial affinity for the polymer. Still another object of the invention is the mechanism whereby the above treated organoclay has little affinity for the polymer and is repulsed to the polymer-polymer or polymer-solid filler interface or polymer surface.

A still further object of the invention is to provide for the formation of micro-sized nano-structured elements within a polymer by using the afore mentioned organoclays, which benefit the thermoplastic's mechanical properties.

Still another object of the invention is to provide a blend of an organoclay and a thermoplastic that avoids the presence of tactoids and where the organoclay forms microtactoids that are small, uniform and internal stress absorbing that help improve the plastic properties of the blend.

### SUMMARY OF THE INVENTION

The present invention is directed to blends of a thermoplastic material and one or more clays and one or more of resorcinol diphosphate, bis-phenol diphosphate or bis(3-T-Butyl-4 hydroxyphenyl-2,4 Di-T-butylphenyl) resorcinol diphosphate or hydroxyl-derived ethers, esters, and amides where aliphatic fatty acids are added to the molecule at the hydroxyl site. The clay and the diphosphates form microtactoids in the thermoplastic. These microtactoids differ from the traditional tactoids found in clay thermoplastic blends. The traditional tactoids are irregularly shaped and fairly large. The microtactoids are small, uniform and internal stress absorbing.

### DETAILED DESCRIPTION OF INVENTION

Organoclays formed using clay and one or more diphosphates namely, resorcinol diphosphate, bis-phenol diphosphate or bis(3-T-Butyl-4 hydroxyphenyl-2,4 Di-T-butylphenyl) resorcinol diphosphate or hydroxyl-derived ethers, esters, and amides where aliphatic fatty acids are added to the molecule at the hydroxyl site can form well dispersed nanocomposites. The diphosphate compounds or the derivatives thereof are blended with a nanoclay which may be a smectite clay. The smectite clay can be a natural or synthetic clay mineral selected from the group consisting of hectorite, montmorillonite, bentonite, beidetite, saponite, stevensite and mixtures thereof. Montmorillonite is a preferred smectite clay. The preferred composition can have about 1% to 50% by weight organoclay with the balance thermoplastic. More preferably, the organoclay can be present in the range of about 5% to 40% by weight organoclay with the balance thermoplastic. Most preferably, the organoclay can be present in the range of about 5% to about 30% by weight organoclay with the balance thermoplastic.

The organoclay can be made up of a blend of about 1% to 30% by weight diphosphate and the balance clay. More preferably, the organoclay can be made up of about 1% to about 20% by weight diphosphate and the balance clay Preferred thermoplastic materials include ABS (acetyl-butyl-styrene copolymer) as well as EVA (ethylene vinyl acetate) and PMMA (polymethyl methacrylate)

In these materials phosphorous and aromatic portions of the surface treatments allow for complete exfoliation of the clay crystals. This is to say that under melt conditions and sheer, these organoclays uniformly distribute them selves and do not remain as tactoids in the material.

Highly loaded, filled plastic pellets of thermoplastic and organoclay can be used as masterbatch delivery systems for other plastics where the organoclay's exfoliation rate was less in these plastics than the exfoliation rate of ABS, EVA or PMMA. The thermoplastic can be a single thermoplastic material or a blend of thermoplastics.

In the case where the polymer is blended with an immiscible polymer or polymers, the domain size for the polymers will shrink and be compatiblized with the organoclay being spatially located throughout the material as well as at the polymer-polymer interface. The organoclay compatiblizes the blend by absorbing and decreasing the interstitial energy between polymer domains.

In instances where the polymer does not have an affinity for the clay to be blended. The polymer can receive a masterbatch from a polymer that is well exfoliated such as ABS, EVA or PMMA. This results in a polymer/polymer blend with the dominant properties of the majority polymer being imparted to the new nanocomposite. The fact that only one phase carries the polymer does not prevent the dispersion of the exfoliated phase carrying plastic to be so well distributed so as to;
1) Encase individual crystals as well as small groups of exfoliated crystals in highly dispersed particles throughout the majority polymer matrix.
2) Boost the mechanical properties; such as flexural modulus as if it was exfoliated uncoated by the secondary masterbatch-polymer.

In cases where the organoclay is not compatible with either material, the clay goes to the interface of the two materials; and compatiblizes the blend at the interface between two polymers even though it exfoliates in neither plastic. In this case all the organoclay is located at the interface and the polymer domains have shrunk leading to greatly increased mechanical properties over the non-clay control blend.

In cases where exfoliation is partial; then unusual microstructures can occur forming a new phase in the equilibrium of tactoids/exfoliated phase. In these cases, the clay molecules are intercalated with the organic treatment described in this invention. They do not all exfoliate. Instead of having tactoids; as is normally the case with many quaternary amine treated organoclays, there is the formation of an intermediate species called a nano-compatiblized microtactoids. These differ greatly at a microscopic level from tactoids. They are at the limit of micron and nano sized instead of being much larger and are uniformly shaped and distributed. Instead of being irregular in distribution and size they are highly uniform in size and distribution, unlike tactoids. Unlike the tactoids which are detrimental to nanoscale induced macro mechanical properties, nano-compatiblized microtactoids are beneficial to mechanical properties and anneal internal stresses inside the plastic matrix. The microtactoids produced in the blends of the present invention are generally football shaped and have a length along the long axis of about 0.9 micron and a length of about 0.3 micron about the equator. The microtactoids are uniformly dispersed throughout the blend and separated from each other by about 3 microns±10%

### EXAMPLES

1) High Impact Polystryrene (HIPS) was blended with RDP treated organoclay. The organoclay was made up of 5% by weight of the diphosphate with the remainder clay. TEM imaging at 20,000 times magnification showed distinct football shaped microtactoids whose dimensions were ˜clay 10-platelets diameter in the center and ˜30 platelets long. In addition the nanocompatiblized microtactoids were evenly distributed throughout the matrix at 3 microns+/−3 microns of distance interval. TEM images at 100,000 time magnification showed both exfoliation and intercalation of the clay crystals in the polymer matrix. Flexural modulus (FM) had increased 12% and other mechanical properties were well maintained without significant decrease.
2) Polypropylene was blended with an organoclay blend of RDP treated sodium bentonite in a 30 mm twin barrel coaxial extruder. The organoclay was made up of 10% RDP and the remainder sodium bentonite. Pellets were made and sent for macro-mechanical testing and transmission electron microscopy (TEM) at 20,000 and 100,000 times magnification. TEM imagery showed no exfoliation of the clay and mechanical increases were modest at X<10% for flexural modulus (FM).

In a second aspect polypropylene was blended with a masterbatch made up of 55% by weight RDP and 45% by weight PMMA. The based PMMA masterbatch was then added to the polypropylene so that there was 89% by weight polypropylene 11% masterbatch using the same extruder. The resulting TEM images showed well exfoliated clay particles encapsulated in PMMA coatings to make a very uniform material under TEM. The macro mechanical flexural modulus (FM) was greatly improved; validating the nanocomposite structure with 22% increase in value.
3) In another example polypropylene was blended with RDP treated sodium bentonite. The RDP treated sodium bentonite had 10% by weight RDP, the balance clay. The organoclay blend made up 5% of the polypropylene 20% by weight HDPE was added to the blend in a 30 mm twin barrel coaxial extruder. The result was excellent processability and greatly improved mechanical values (FM of 54%); even though the clay fails to exfoliate in either plastic and it rejected to the interface. The polymer domains were greatly shrunk and rendered uniform under TEM compared with non-clay bearing controls. In addition, the polypropylene-HDPE-organoclay blend acts as though it only has one glass transition temperature under melt conditions. The non clay bearing control has two discernable glass transition temperatures when using dynamic mechanical analysis. In addition properties such as tensile strength at yield increased, as did tensile at break, and notched izod impact values. This result is unusually good even in cases where there is exfoliation in a thermoplastic.
4) In yet another example ABS, HIPS and EVA were compounded in a 30 mm twin barrel coaxial extruder with 5% RDP treated clay. The RDP treated clay was made up of 10% RDP and 90% clay. TEM images showed complete exfoliation at 20,000 times magnification and clear particle separation at 100,000 times magnification. The mechanical property increases on all cases were significantly improved (FM>10% increase) when compared to the control non-nanocomposite virgin plastic.

What is claimed:

1. A thermoplastic nanocomposite comprising a blend of a thermoplastic polymer and an organoclay wherein said organoclay forms microtactoids in said thermoplastic polymer.

2. The nanocomposite according to claim 1 wherein said microtactoids are uniform in shape and distribution throughout the blend.

3. The nanocomposite according to claim 2 wherein said microtactoids are generally football shaped with a center axis and an equator.

4. The nanocomposite according to claim 3 wherein said microtactoids have a length of about 0.9 micro along said center axis.

5. The nanocomposite according to claim 4 wherein said microtactoids have a width of about 0.3 micron about said equator.

6. The nanocomposite according to claim 5 wherein said microtactoids are separated from each other by about 3 microns±110%.

7. The nanocomposite according to claim 6 wherein said thermoplastic polymer is acetyl-butyl styrene copolymer (ABS).

8. The nanocomposite according to claim 6 wherein said thermoplastic polymer is ethylene vinyl acetate (EVA).

9. The nanocomposite according to claim 6 wherein said thermoplastic polymer is polymethylmethacrylate.

10. The nanocomposite according to claim 6 wherein said organoclay is a blend of a clay and a diphosphate.

11. The nanocomposite according to claim 10 wherein said diphosphate is a resorcinol diphosphate or a derivative thereof.

12. The nanocomposite according to claim 10 wherein said diphosphate is bis-phenol diphosphate or a derivative thereof.

13. The nanocomposite according to claim 10 wherein said diphosphate is bis(3-T-Butyl-4 hydroxyphenyl-2,4 Di-T-butylphenyl) resorcinol diphosphate or a derivative thereof.

14. The nanocomposite according to claim 6 wherein said diphosphate has a fatty acid group added to the molecule at the site of an hydroxyl group on said diphosphate.

15. The nanocomposite according to claim 6 wherein said microtactoids are comprised of intercalated clay platelets.

16. The nanocomposite according to claim 1 wherein said blend of thermoplastic and organoclay is a masterbatch that has been added to a second thermoplastic different from said first thermoplastic polymer.

17. The method of forming a thermoplastic nanocomposite comprising blending a thermoplastic polymer and an organoclay said organoclay forming microtactoids in said thermoplastic polymer.
